(19) United States
(12) Patent Application Publication
(10) Pub. No.: US 2020/0202272 A1
(43) Pub. Date: Jun. 25, 2020

(54) METHOD AND SYSTEM FOR ESTIMATING EXPECTED IMPROVEMENT IN A TARGET METRIC FOR A CONTACT CENTER

(71) Applicant: Genesys Telecommunications Laboratories, Inc., Daly City, CA (US)

(72) Inventors: Bharath Aravamudhan, Chennai (IN); Conor McGann, Daly City, CA (US); Bogdan Neacsa, Daly City, CA (US)

(21) Appl. No.: 16/720,271

(22) Filed: Dec. 19, 2019

Related U.S. Application Data
(60) Provisional application No. 62/783,188, filed on Dec. 20, 2018.

(51) Int. Cl. G06Q 10/06; G06Q 30/00; G06N 3/08; G06N 20/00

(52) U.S. Cl. CPC G06Q 10/06311; G06N 20/00; G06N 3/08; G06Q 30/016

(57) ABSTRACT

A system and method are presented for estimating expected improvement in a target metric for a contact center. A lift estimation analysis is performed to estimate the benefit the contact center is likely to achieve assuming different agent availability conditions for a specific future time interval. Historic data is extracted over a set time interval and used to create new datasets for training and testing. The historic data comprises interaction data and associated outcomes for the interaction data. A predictive model is constructed and used to analyze the test dataset by predicting an outcome score for a target metric and estimating an expected lift.

### CROSS REFERENCE TO RELATED APPLICATION

This application claims the benefit of U.S. Provisional Patent Application No. 62/783,188, titled “LIFT ESTIMATION ANALYSIS FOR CONTACT CENTER ROUTING”, filed in the U.S. Patent and Trademark Office on Dec. 20, 2018, the contents of which are incorporated herein.

### BACKGROUND

The present invention generally relates to telecommunications systems and methods, as well as the analysis of contact center metrics. More particularly, the present invention pertains to the optimization of key performance indicators and the benefits thereof to the contact center.

### SUMMARY

A system and method are presented for estimating expected improvement in a target metric for a contact center. A lift estimation analysis is performed to estimate the benefit the contact center is likely to achieve assuming different agent availability conditions for a specific future time interval. Historic data is extracted over a set time interval and used to create new datasets for training and testing. The historic data comprises interaction data and associated outcomes for the interaction data. A predictive model is constructed and used to analyze the test dataset by predicting an outcome score for a target metric and estimating an expected lift.

In one embodiment, a method is presented for estimating expected improvement in a target metric of a contact center, the method comprising: extracting a first dataset over a set time interval from a database associated with the contact center, wherein the dataset comprises: a plurality of past interaction data between customers and agents of the contact center, associated outcomes for the interaction data, and future availability of agents from the past interaction data; creating a second dataset from the first dataset, wherein the second dataset comprises a training dataset and a test dataset; building, by a predictor training server, a predictive model using the training dataset wherein the predictor training server applies a machine-learning algorithm which seeks to minimize the error in difference between true outcome for a target metric of a given interaction and a predicted outcome of the given interaction; analyzing, by an analytics server, the test dataset using the predictive model by predicting an outcome score for the target metric for an interaction handled by an agent from a pool of the agents available in the future; estimating the expected improvement for the target metric when each interaction is handled by an agent meeting a threshold for the outcome score; and generating, by the analytics server, a visual representation comprising the outcome score for the target metric and the expected improvement.

The associated outcomes for the interaction data comprise customer satisfaction survey results. The associated outcomes for the interaction data may also comprise customer satisfaction survey results.

The test dataset comprises a most recent percentage of the first dataset as measured by time over the set time interval and the training dataset comprises a remainder of the first dataset. The most recent percentage may be 20% with the remainder being 80%.

The future availability of agents from the past interaction data comprises a set percentage of a number of the available agents for the contact center.

The machine-learning algorithm comprises decision trees. The machine-learning algorithm may comprise neural networks in another embodiment.

The first dataset further comprises profile information of customers and profile information of agents and the interaction data further comprises a context associated with each interaction. The analyzing is performed for each of the contexts.

In another embodiment, a system of estimating expected improvement in a target metric of a contact center is presented, the system comprising: a processor; and a memory coupled to the processor, wherein the memory stores instructions that, when executed by the processor, cause the processor to: extract a first dataset over a set time interval from a database associated with the contact center, wherein the dataset comprises: a plurality of past interaction data between customers and agents of the contact center, associated outcomes for the interaction data, and future availability of agents from the past interaction data; create a second dataset from the first dataset, wherein the second dataset comprises a training dataset and a test dataset; build, by a predictor training server, a predictive model using the training dataset wherein the predictor training server applies a machine-learning algorithm which seeks to minimize the error in difference between true outcome for a target metric of a given interaction and a predicted outcome of the given interaction; analyze, by an analytics server, the test dataset using the predictive model by predicting an outcome score for the target metric for an interaction handled by an agent from a pool of the agents available in the future; estimate the expected improvement for the target metric when each interaction is handled by an agent meeting a threshold for the outcome score; and generate, by the analytics server, a visual representation comprising the outcome score for the target metric and the expected improvement.

### BRIEF DESCRIPTION OF THE DRAWINGS

FIG. 1 is a diagram illustrating an embodiment of a contact center system.

FIG. 2 is a diagram illustrating an embodiment of a predictive routing server operating as part of the contact center system.

FIG. 3 is a flowchart illustrating an embodiment of a process for estimating expected improvement in a target metric of a contact center.

FIG. 4 is a table illustrating an embodiment of simulated target metrics for agents handling interactions.

FIG. 5A is a diagram illustrating an embodiment of outcome correlation.

FIG. 5B is a diagram illustrating an embodiment of lift estimation for a target metric.

FIG. 6A is a diagram illustrating an embodiment of a computing device.

FIG. 6B is a diagram illustrating an embodiment of a computing device.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present disclosure is directed to a system and method of estimating expected improvement in a target metric of a contact center. When operators of contact centers are seeking to upgrade or otherwise alter existing architecture of a contact center, it may be difficult to quantify the expected benefits to the contact center. This may be true in the addition of a predictive routing system to traditional interaction routing architecture for a contact center. The deployment of a predictive routing system to route interactions in a contact center may use, among other inputs, accumulated agent and customer-agent interaction data, which can permit the contact center operator to analyze omnichannel interactions and outcomes and generate models to predict outcomes. From this analysis by the predictive routing system, combined with machine learning, an optimal match between waiting interactions and available agents may be determined, and the interactions routed accordingly. Reports may also be generated on predicted versus actual outcomes of customer-agent interactions. Further training of the machine-learning model of the predictive routing may be accomplished from the use of actual outcomes, which may improve the accuracy of predicted outcomes between similar customer profiles and agent profiles.

Upon implementing a predictive routing system as part of an existing contact center, it may be desirable for the operator of the contact center to have a quantitative analysis of the benefits of the addition of the predictive routing system to the contact center. Contact centers with an existing store of historic data that includes the type of input data for a predictive routing server, such as agent data and customer-agent interaction data, may be able to leverage the historic data into estimating and modeling how the contact center might have performed with the predictive routing server over a baseline of actual performance information over the same time period. From the modeling of the historic data, a simulation can be performed on historic data to determine agent availability by scoring all agents who are part of a daily agent pool and selecting the maximum scored agent among the pool. Simulations may be run over varying percentages of availability, such as 100% or 50%, and the results verified. In addition, a generated lift curve could also reveal issues underlying with the scoring model as to how well the model discriminates between agents and how reliable the scores are.

Contact Center Systems

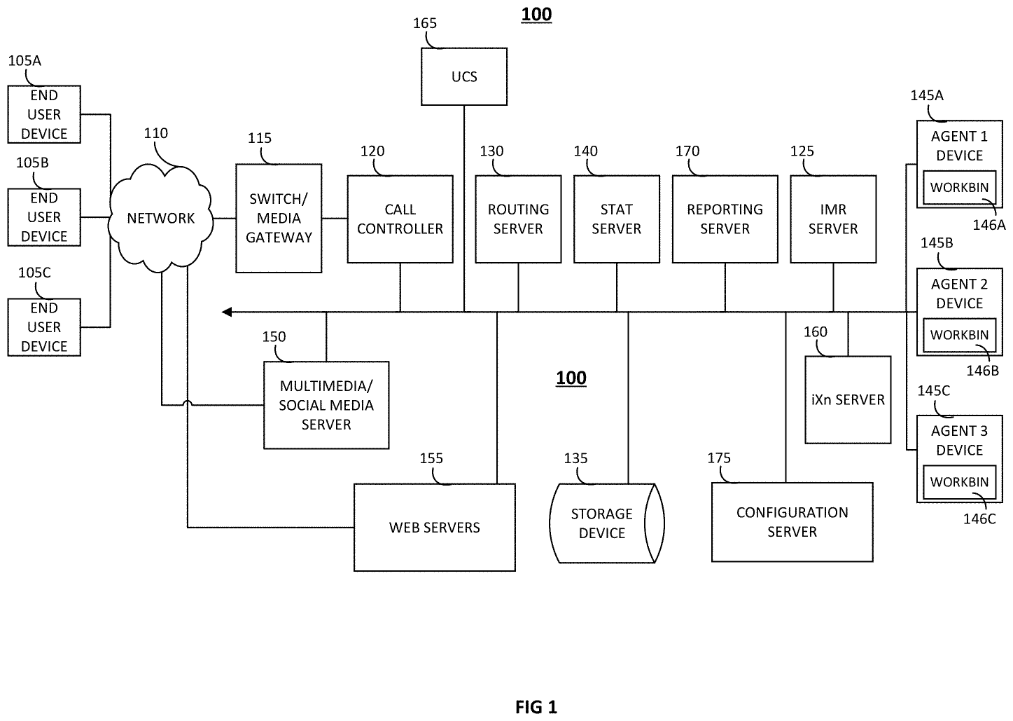

FIG. 1 is a diagram illustrating an embodiment of a communication infrastructure, indicated generally at 100. For example, FIG. 1 illustrates a system for supporting a contact center in providing contact center services. The contact center may be an in-house facility to a business or enterprise for serving the enterprise in performing the functions of sales and service relative to the products and services available through the enterprise. In another aspect, the contact center may be operated by a third-party service provider. In an embodiment, the contact center may operate as a hybrid system in which some components of the contact center system are hosted at the contact center premises and other components are hosted remotely (e.g., in a cloud-based environment). The contact center may be deployed on equipment dedicated to the enterprise or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

Components of the communication infrastructure indicated generally at 100 include: a plurality of end user devices 105A, 105B, 105C; a communications network 110; a switch/media gateway 115; a call controller 120; an IMR server 125; a routing server 130; a storage device 135; a stat server 140; a plurality of agent devices 145A, 145B, 145C comprising workbins 146A, 146B, 146C; a multimedia/social media server 150; web servers 155; an iXn server 160; a UCS 165; a reporting server 170; and a configuration server 175.

In an embodiment, the contact center system manages resources (e.g., personnel, computers, telecommunication equipment, etc.) to enable delivery of services via telephone or other communication mechanisms. Such services may vary depending on the type of contact center and may range from customer service to help desk, emergency response, telemarketing, order taking, etc.

Customers, potential customers, or other end users (collectively referred to as customers or end users) desiring to receive services from the contact center may initiate inbound communications (e.g., telephony calls, emails, chats, etc.) to the contact center via end user devices 105A, 105B, and 105C (collectively referenced as 105). Each of the end user devices 105 may be a communication device conventional in the art, such as a telephone, wireless phone, smart phone, personal computer, electronic tablet, laptop, etc., to name some non-limiting examples. Users operating the end user devices 105 may initiate, manage, and respond to telephone calls, emails, chats, text messages, web-browsing sessions, and other multi-media transactions. While three end user devices 105 are illustrated at 100 for simplicity, any number may be present.

Inbound and outbound communications from and to the end user devices 105 may traverse a network 110 depending on the type of device that is being used. The network 110 may comprise a communication network of telephone, cellular, and/or data services and may also comprise a private or public switched telephone network (PSTN), local area network (LAN), private wide area network (WAN), and/or public WAN such as the Internet, to name a non-limiting example. The network 110 may also include a wireless carrier network including a code division multiple access (CDMA) network, global system for mobile communications (GSM) network, or any wireless network/technology conventional in the art, including but not limited to 3G, 4G, LTE, etc.

In an embodiment, the contact center system includes a switch/media gateway 115 coupled to the network 110 for receiving and transmitting telephony calls between the end users and the contact center. The switch/media gateway 115 may include a telephony switch or communication switch configured to function as a central switch for agent level routing within the center. The switch may be a hardware switching system or a soft switch implemented via software. For example, the switch 115 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, an agent telephony or communication device. In this example, the switch/media gateway establishes a voice path/connection (not shown) between the calling customer and the agent telephony device, by establishing, for example, a connection between the customer's telephony device and the agent telephony device.

In an embodiment, the switch is coupled to a call controller 120 which may, for example, serve as an adapter or interface between the switch and the remainder of the routing, monitoring, and other communication-handling components of the contact center. The call controller 120 may be configured to process PSTN calls, VoIP calls, etc. For example, the call controller 120 may be configured with computer-telephony integration (CTI) software for interfacing with the switch/media gateway and contact center equipment. In an embodiment, the call controller 120 may include a session initiation protocol (SIP) server for processing SIP calls. The call controller 120 may also extract data about the customer interaction, such as the caller's telephone number (e.g., the automatic number identification (ANI) number), the customer's internet protocol (IP) address, or email address, and communicate with other components of the system 100 in processing the interaction.

In an embodiment, the system 100 further includes an interactive media response (IMR) server 125. The IMR server 125 may also be referred to as a self-help system, a virtual assistant, etc. The IMR server 125 may be similar to an interactive voice response (IVR) server, except that the IMR server 125 is not restricted to voice and additionally may cover a variety of media channels. In an example illustrating voice, the IMR server 125 may be configured with an IMR script for querying customers on their needs. For example, a contact center for a bank may tell customers via the IMR script to ‘press 1’ if they wish to retrieve their account balance. Through continued interaction with the IMR server 125, customers may be able to complete service without needing to speak with an agent. The IMR server 125 may also ask an open-ended question such as, “How can I help you?” and the customer may speak or otherwise enter a reason for contacting the contact center. The customer's response may be used by a routing server 130 to route the call or communication to an appropriate contact center resource.

If the communication is to be routed to an agent, the call controller 120 interacts with the routing server (also referred to as an orchestration server) 130 to find an appropriate agent for processing the interaction. The selection of an appropriate agent for routing an inbound interaction may be based, for example, on a routing strategy employed by the routing server 130, and further based on information about agent availability, skills, and other routing parameters provided, for example, by a statistics server 140.

In an embodiment, the routing server 130 may query a customer database, which stores information about existing clients, such as contact information, service level agreement (SLA) requirements, nature of previous customer contacts and actions taken by the contact center to resolve any customer issues, etc. The database may be, for example, Cassandra or any NoSQL database, and may be stored in a mass storage device 135. The database may also be a SQL database and may be managed by any database management system such as, for example, Oracle, IBM DB2, Microsoft SQL server, Microsoft Access, PostgreSQL, etc., to name a few non-limiting examples. The routing server 130 may query the customer information from the customer database via an ANI or any other information collected by the IMR server 125.

Once an appropriate agent is identified as being available to handle a communication, a connection may be made between the customer and an agent device 145A, 145B and/or 145C (collectively referenced as 145) of the identified agent. While three agent devices are illustrated in FIG. 1 for simplicity, any number of devices may be present. Collected information about the customer and/or the customer's historical information may also be provided to the agent device for aiding the agent in better servicing the communication and additionally to the contact center admin/supervisor device for managing the contact center. In this regard, each device 145 may include a telephone adapted for regular telephone calls, VoIP calls, etc. The device 145 may also include a computer for communicating with one or more servers of the contact center and performing data processing associated with contact center operations, and for interfacing with customers via voice and other multimedia communication mechanisms.

The contact center system 100 may also include a multimedia/social media server 150 for engaging in media interactions other than voice interactions with the end user devices 105 and/or web servers 155. The media interactions may be related, for example, to email, vmail (voice mail through email), chat, video, text-messaging, web, social media, co-browsing, etc. The multi-media/social media server 150 may take the form of any IP router conventional in the art with specialized hardware and software for receiving, processing, and forwarding multi-media events.

The web servers 155 may include, for example, social interaction site hosts for a variety of known social interaction sites to which an end user may subscribe, such as Facebook, Twitter, Instagram, etc., to name a few non-limiting examples. In an embodiment, although web servers 155 are depicted as part of the contact center system 100, the web servers may also be provided by third parties and/or maintained outside of the contact center premise. The web servers 155 may also provide web pages for the enterprise that is being supported by the contact center system 100. End users may browse the web pages and get information about the enterprise's products and services. The web pages may also provide a mechanism for contacting the contact center via, for example, web chat, voice call, email, web real-time communication (WebRTC), etc. Widgets may be deployed on the websites hosted on the web servers 155.

In an embodiment, deferrable interactions/activities may also be routed to the contact center agents in addition to real-time interactions. Deferrable interaction/activities may comprise back-office work or work that may be performed off-line such as responding to emails, letters, attending training, or other activities that do not entail real-time communication with a customer. An interaction (iXn) server 160 interacts with the routing server 130 for selecting an appropriate agent to handle the activity. Once assigned to an agent, an activity may be pushed to the agent, or may appear in the agent's workbin 146A, 146B, 146C (collectively 146) as a task to be completed by the agent. The agent's workbin may be implemented via any data structure conventional in the art, such as, for example, a linked list, array, etc. In an embodiment, a workbin 146 may be maintained, for example, in buffer memory of each agent device 145.

In an embodiment, the mass storage device(s) 135 may store one or more databases relating to agent data (e.g., agent profiles, schedules, etc.), customer data (e.g., customer profiles), interaction data (e.g., details of each interaction with a customer, including, but not limited to: reason for the interaction, disposition data, wait time, handle time, etc.), and the like. In another embodiment, some of the data (e.g., customer profile data) may be maintained in a customer relations management (CRM) database hosted in the mass storage device 135 or elsewhere. The mass storage device 135 may take form of a hard disk or disk array as is conventional in the art.

In an embodiment, the contact center system may include a universal contact server (UCS) 165, configured to retrieve information stored in the CRM database and direct information to be stored in the CRM database. The UCS 165 may also be configured to facilitate maintaining a history of customers' preferences and interaction history, and to capture and store data regarding comments from agents, customer communication history, etc.

The contact center system may also include a reporting server 170 configured to generate reports from data aggregated by the statistics server 140. Such reports may include near real-time reports or historical reports concerning the state of resources, such as, for example, average wait time, abandonment rate, agent occupancy, etc. The reports may be generated automatically or in response to specific requests from a requestor (e.g., agent/administrator, contact center application, etc.).

The configuration server 175 may be configured to store agent profile information associated with agents that operate an agent device 145. The information associate with an agent access through configuration server 175 may include, but are not limited to, an unique agent identification number, agent activity, an agent grouping of the contact center, language skills, and assignment to particular contexts of interactions. The configuration server 175 may also associate certain statistic from reporting server 175 with particular agents. The associated statistics may include, but are not limited to, statistics concerning agent utilization, first call resolution, average handle time, and retention rate.

The various servers of FIG. 1 may each include one or more processors executing computer program instructions and interacting with other system components for performing the various functionalities described herein. The computer program instructions are stored in a memory implemented using a standard memory device, such as for example, a random-access memory (RAM). The computer program instructions may also be stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In an embodiment, the terms “interaction” and “communication” are used interchangeably, and generally refer to any real-time and non-real-time interaction that uses any communication channel including, without limitation, telephony calls (PSTN or VoIP calls), emails, vmails, video, chat, screen-sharing, text messages, social media messages, WebRTC calls, etc.

In an embodiment, the premises-based platform product may provide access to and control of components of the system 100 through user interfaces (UIs) present on the agent devices 145A-C. Within the premises-based platform product, the graphical application generator program may be integrated which allows a user to write the programs (handlers) that control various interaction processing behaviors within the premises-based platform product.

As noted above, the contact center may operate as a hybrid system in which some or all components are hosted remotely, such as in a cloud-based environment. For the sake of convenience, aspects of embodiments of the present invention will be described below with respect to providing modular tools from a cloud-based environment to components housed on-premises.

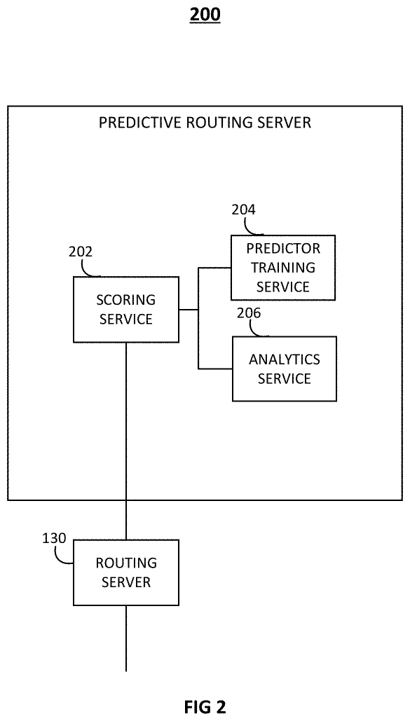

FIG. 2 is a diagram illustrating an embodiment of a predictive routing server operating as part of the contact center system. A predictive routing server 200, operatively coupled with routing server 130 and contact center 100 (FIG. 1) may be configured to use historical and real-time data, along with artificial intelligence, to identify factors that influence customer-to-business interactions. These data may include favored communication channel, past product purchases and service requests, and recent transaction activity. The predictive routing server 200 may combine this information with agent profiles and factors (e.g., agent skills, interaction history, and business outcome data) to predict ideal customer-agent matches. The predictive routing server 200 may include the core machine learning server that is capable of performing a number of functions, as described herein. In addition, the predictive routing server 200 may host a number of services within, including a scoring service 202, model training service 204, and an analytics server 206.

The predictive routing server 200 may permit inputs of customer profile data, agent profile data, interaction data, and outcome data associated with the interaction data. The inputs may be obtained from a storage device 135, a configuration server 175, or other appropriate hardware for maintaining the data. The predictive routing server 200 is configured to perform batch processing to run a number of analytical processes, for example variance analysis and feature analysis on historical data. A variance analysis performed by the predictive routing server 200 may provide analysis on how a selected target metric may vary across different agent populations. A variance analysis may be generated for inter-agent variance, which may show how well individual agents perform, including an identification of the highest-performing and weakest agents. A variance analysis may also be generated for agent variance, which may show the range of agent performance for each category as specified group of agents. Examples of a grouping of agents can include, but are not limited to, an agent's role and an agent's skills. A feature analysis performed by the predictive routing server 200 is configured to generate predictors and models for the predictive routing server 200. In particular, generated predictors and models enables the contact center operator to determine which factors have the most impact on a selected target metric. Examples of factors that determine the impact on a selected target metric may include agent characteristics and agent behavior, customer characteristics, and behavior.

The predictive routing server 200 may be configured to train predictive models for real-time scoring use. In other words, a generated predictive model, detailed below, may be used to determine the routing of incoming interaction to an available agent. The predictive model used by the predictive routing server 200 may generate, upon receipt of the routing server 130 of an interaction, a real-time list of agents that are available to handle the interaction are scored against the model, and then route the interaction to an available agent based on the score of the model. Additionally, the predictive routing server 200 may store predicted and actual outcomes of agent-customer interactions and generate reports and dashboards tracking performance of models for target metrics.

The scoring service 202 may be configured to receive a model trained on the predictive routing server 200. The received trained model can be available on the scoring server 202 as a worker to take scoring requests that may come from other systems of the contact center 100. In an embodiment, the predictive routing server 200 may have multiple workers of scoring server 202 to score requests for a number of target metrics. The scoring server 202 operating as a worker can be available as a scoring service in contact center environment. In a an embodiment, dedicated instances of scoring service 202 are provided for each provided scoring service of the predictive routing server 200.

The model training service 204 may be configured as a dedicated service to analyze received data and train models for the predictive routing server 200. Model training service 204 may be configured to train a model by (i) transforming historical data, (ii) generating new features, (iii) aggregating outcomes, (iv) running feature analysis, and (v) training and testing for regression and classification models. The model training service 204 may be configured to utilize machine learning algorithms to train models. Machine learning algorithms deployed by the model training server 204 may include, but are not limited to, neural networks and decision trees.

The analytics service 206 may be configured to perform analysis on different datasets to help guide configuration of usable datasets and target metrics to optimize datasets to consume for model training. The analytics service 206 may perform aggregation on datasets as part of the scoring service worker. In an embodiment, the analytics service may include dedicated processes to run feature analysis, variance analysis, simulations, A/B testing, and lift estimation.

However, embodiments of the present disclosure are not limited to predictive routing (such as the predictive routing server described above) and may also be applied to other service(s). Embodiments of the present disclosure are not limited to a particular architecture for the contact center. For example, embodiments of the present disclosure may also be applied in data centers operated directly by the contact center or within the contact center, where resources within the data center may be dynamically and programmatically allocated and/or deallocated from a group. Embodiments of the present disclosure may also be deployed with remotely-hosted or cloud-based infrastructure.

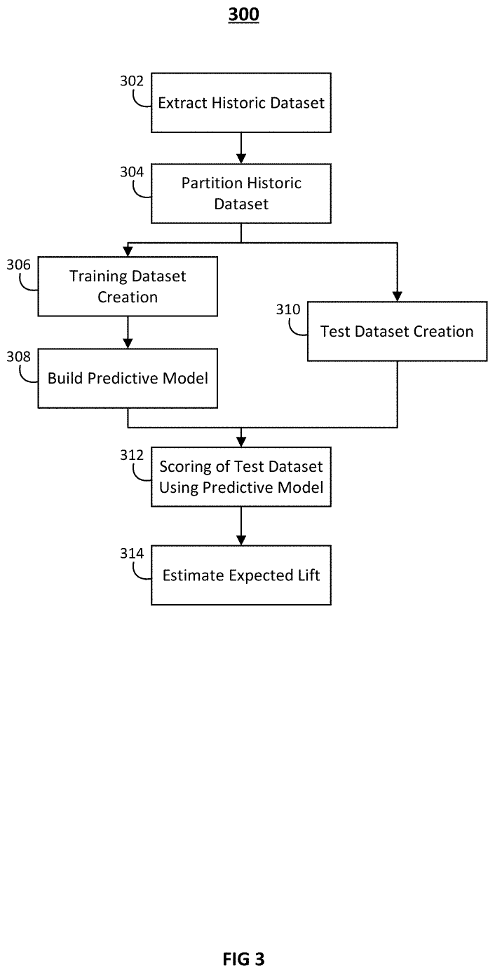

FIG. 3 is a flowchart illustrating an embodiment of a process for estimating expected improvement in a target metric of a contact center, indicated generally at 300. A target metric that may have its improvement estimated may include, but not be limited to, maximizing net promoter score (NPS), average handle time (AHT), and retention rate.

The process 300 begins and at operation 302, extraction of an historic dataset from a contact center database over a prior time interval occurs. For example, a contact center may generate through its daily operation a voluminous amount of historic data from prior interactions between customers and agents handled by the contact center. The historic dataset may contain interaction data, agent data, customer data, and results from customer satisfaction surveys (CSAT).

The interaction data from the historic dataset may include identification of the customer and the agent that interacted during a particular interaction. For example, each customer may have a unique identification number associated with the customer profile that specifically identifies the customer that contacted the contact center. As an additional example, each agent may have a unique identification number or employee number associated with the agent of the contact center. The customer unique identification number and the agent unique identification number could be included in the interaction data. Additional information associated with, or contained in, the interaction data may include interaction duration, response time, queue time, routing point time, total duration, customer engagement time, customer hold time, and interaction handle time. The interaction data may also contain the context of the interaction, which categorizes the purpose of the interaction. For example, in a contact center that handles a multiplicity of different types of inbound inquiries from a customer, examples of the different types of inbound inquiries might comprise billing, sales, and technical support. The context of “sales” could be associated with the interaction data for a customer that contacts the contact center of the business to inquiry about purchasing a new service.

In an embodiment, the set time interval is a set amount of historic data as determined by a particular time interview. For example, the most-recent six months' worth of data from the contact center could be the set time interval for the amount of historic data. The time interval may be comprised of one continuous length of time or a number of distinct time intervals. The time interval may seek to omit time periods where there is an absence of data from the historic data, due to a loss of data from the storage medium, for example. The length of the set time interval should be appropriately set to permit sufficient data for building the predictive model and analysis by an analytics server.

The historic database may also contain information concerning the outcomes for the interactions handled through the contact center between the agents and customers. In an embodiment, the associated outcomes for the interaction data may be first call resolution (FCR) data. A variant of the FCR data may be first call resolution within seven days (FCR7) data, which takes into account whether a second interaction between a customer and agent was necessary for the same matter or context within seven days of the first interaction. In an embodiment the associated outcomes for the interaction data may be customer satisfaction survey results. Similar metrics to FCR that account for different types of interactions handled by a contact center 100 may also be used to determine associated outcomes for the interaction data.

The historical database may also contain information concerning the agents that were noted as available agents for the contact center during the set time interval. The historic database may provide additional granularity of detail for when an agent was available to handle an interaction routed through the contact center. For example, the historic database may provide the specific days for when an agent was marked as available to handle an interaction. The historic database may also provide specific shifts, hours, or minutes of the day when an agent was marked as available to handle an interaction.

As disclosed further below, in an embodiment, it may be advantageous to recreate the original routing scenario as close as possible for modeling and simulating the contact center with predictive routing. Accordingly, it may be desirable for the choice of agents to be the same as that of the existing baseline routing, at the granularity of a day. In other words, while scoring an interaction using the predictive model, the model is constrained to consider only those agents who had handled calls through baseline routing on the day of the interaction. In addition, the historical database may contain additional characteristics of agents, such as whether an agent was assigned to handle specific types of interactions (based on context or communication-type), or otherwise grouped within the pool of agents. In an embodiment, when additional limits or groupings of agents are deployed in the contact center, it may be desirable to choose the values of those setting as the same as applicable on the day of the interaction (i.e. selecting one of the interactions handled by an agent on that day and extract those corresponding values.)

In an embodiment, it may be assumed that an agent profile is the same for the extracted granularity of the agent information. For example, agent information is available at a day-by-day level of granularity, then it may be assumed that the agent profile remains the same throughout the given day.

At operation 304, partitioning of the extracted historic dataset from a contact center database occurs. In an embodiment, a split of the historic dataset into two temporal periods occurs at operation 304. For example, a historic dataset containing data (e.g., interaction data, agent data, and customer data) has been extracted for the specific months for a given calendar year (e.g., January through October). In this example, it is desired that the partition of operation 304 creates an 80:20 split of the extracted historic dataset, and thus creates two datasets: one containing the extracted interaction data, agent data, and customer data for January through August; and one containing the extracted interaction data, agent data, and customer data for September through October. In an embodiment, the earliest temporal partition of the historic dataset is used to create the training dataset in operation 306, while the latest temporal partition of the historic dataset is used to create the test dataset in operation 310.

At operation 308, a predictive model of the interaction routing from the contact center is created utilizing the training dataset from operation 306. In an embodiment, the predictive model may use the training dataset wherein the predictive routing server applies a machine-learning algorithm, which seeks to minimize the error in difference between true outcome for a target metric of a given agent-customer interaction and a predicted outcome of the given agent-customer interaction. As an example, the predictive model is generated by inputting the training dataset through a selected machine-learning algorithm, generating a predicted outcome of each of a given agent-customer interaction from the training dataset and an error from an actual outcome for the given agent-customer interaction is determined. The machine-learning algorithm continues to be applied to the predicted outcomes for the training dataset until the error across the differences predicted outcomes and actual outcomes is minimized for all of the interactions from the agent-customer interactions in the training dataset.

In an embodiment, the machine-learning algorithm applied at operation 308 to build the predictive model can be a decision tree, neural network, or other suitable approach. In an example, the model training service 204 (FIG. 2) may be used to perform operation 308 (FIG. 3), although other components of a predictive routing server 200 may be utilized as part of the model building.

In an embodiment, the predictive model is generated at operation 308 for a number of identified contexts from the interactions from the historical agent-customer interaction data. For example, a contact center 100 may have a number of contexts identified for the customer's intention of an interaction. In an example, the predictive model generated at operation 308 may seek to minimize the error within each of the identified contexts for the contact center 100.

At operation 312, the test dataset generated in operation 310 is scored using the predictive model constructed in operation 308. In an embodiment, the test dataset is scored through analyzing, by the analytics service of the predictive routing server, the test data using the predictive model. This may be accomplished by predicting an outcome score for the target metric for a given agent-customer interaction handled by an agent from a pool of simulated available agents on the day of the agent-customer interaction. An expected lift is then estimated for when each interaction is handled by its best-scored agent from the pool of simulated available agents on the day of the agent-customer interaction.

In an embodiment, the number of simulations may be set for operation 312 for how many times scoring the test dataset select subsets of agents, whereby each subset of agents is used in one simulation. The predictive routing server determines an average across the specified number of simulations to account for the randomness in subset selection. The calculated agent availability figure may determine the size of these subsets. In an embodiment, scoring the test dataset may be performed for different agent availability percentages. For example, agent availability may be varied from 0.01, when only 1% of total agents are available, to 1, when 100% of agents are available. In another example, 50% availability uses random selections of half the total agents. In yet another example, 25% availability uses simulations that each pick a random 25% of the total number of agents.

In an embodiment, the number of samples to use from the test dataset for operation 312 may be varied. For example, the number of samples might be approximately 30 times the number of agents (i.e., an average of 30 samples per agent). It should be noted, however, that the number of samples should not exceed the number of records in the test dataset. As a result, the method of 300 would disregard the excess number and run reports for only the available number of samples in the test dataset.

In an embodiment, operation 312 may permit inclusion of a parameter to use to group interactions for estimation. For example, only agents who handled interactions of the type specified in the specified parameter value are used in the estimation for that group.

The expected lift in the target metric may be dependent on the available agent pool. In an embodiment, candidate agent pools of different sizes may be created to study the increase or decrease in lift. Agent availability may be defined as the fraction of total agents who handled calls on the day of the interaction. In an embodiment, to simulate 100% agent availability, for each interaction, all the agents who are part of the daily agent pool determined for a set day are scored and the maximum scored agent among them is agent selected by the generated predictive model. A 50% agent availability may be determined by randomly selecting half of the agents from the daily agent pool, scoring them and picking the maximum-scored agent among the selected half. In an embodiment, to ensure the estimated lift is not occurring by chance, the random selection of agents may be repeated a number of times, and then the lift is averaged across the runs. For example, the random selection and scoring of agents may be simulated 100 times, selecting the highest-scoring agent from each simulation selected, and then the 100 scores are averaged to determine the estimated lift.

In an embodiment, the scores obtained from the predictive model may be error-prone and may need to be adjusted in order for the predictive model to provide a reliable estimate. For a given historic agent-customer interaction, when the chosen agent in the predictive model based on a maximum score for a target metric matches with the agent who originally handled the interaction through the historic routing information, this information may be used to correct for bias in the predicted scores, if any exists. Since the number of interactions for which the two agents selected by the two different routing policies match is likely to be a small fraction of the total interactions, the estimation algorithm also amplifies the correction to account for other interactions where the actual agent and the predictive-routing-suggested agent do not match. The error-correction algorithm further assumes that the baseline routing had chosen agents randomly to determine the amplification factor. The estimate is expected to be accurate if either the predicted score or the amplification factor is accurate, but both could have errors associated with them that are likely to impact the estimate. The bias in the predicted score is determined based on the sample of interactions where the predictive-routing-chosen agent and the actual agents who handled them match, and this correction is amplified and applied to all the samples to account for the overall bias.

At operation 314, estimating the expected lift from the scoring of the test dataset from operation 312 is performed. The expected lift may be estimated by generating through an analytics service of the predictive routing server, whereby the expected lift is determined from where each interaction in the contact is handled by its best-scored agent from a pool of simulated available agents during a certain timer period for the agent-customer interaction. The lift estimator uses the original interaction-agent assignment as captured in the historic dataset, the corresponding outcome, and the predicted scores by the developed model for the same set of interactions and agents, to estimate the performance the contact center would have seen had the agent assignment been using the predictive model. In an embodiment, the estimated lift may be determined through deployment of a doubly robust estimator, although other techniques may be applied. See Dudik, M., Langsford, J., Li, L.; “Doubly Robust Policy Evaluation and Learning,” Proceedings of the 28th International Conference on Machine Learning, 2011. The expected lift may be graphically displayed through a graph which demonstrates the expected lift of the target metric for the contact center, wherein the graph contains the outcome score for the target metric.

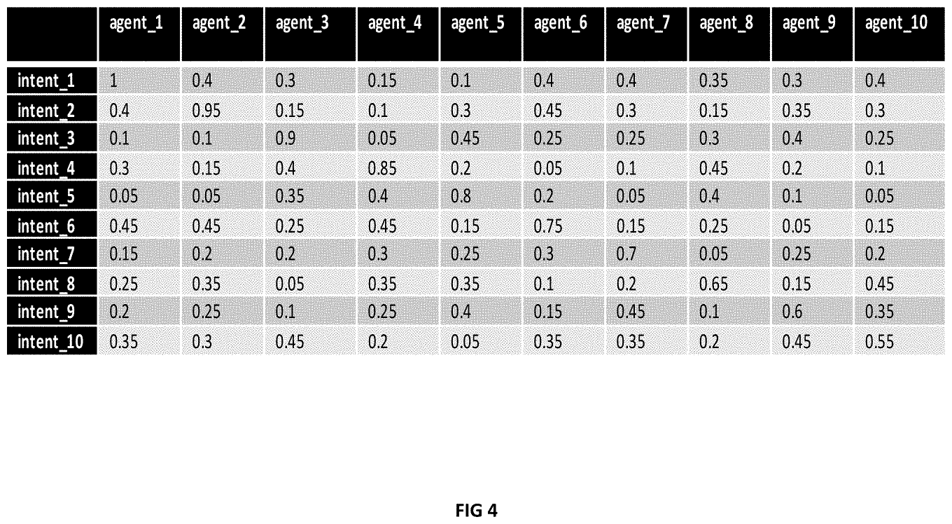

FIG. 4 is a table illustrating an exemplary embodiment of simulated target metrics for agents of the contact center. Specifically, FIG. 4 generally illustrates the distribution of agent performance for scoring the test dataset using the predictive model from operation 312 of method 300. In order to demonstrate the working of lift estimation on the scores obtained from different scoring models in operation 314 of method 300, an artificial dataset using the distribution of agent performances is shown in FIG. 4. The agent performances may be modeled based for a selected target metric like First Call Resolution (FCR), wherein the simulation seeks to optimize by selecting agents with higher performance value. For the FCR target metric, it may be desirable to achieve a maximum value of FCR (e.g. 100% FCR or a value of 1 in decimal form). Other target metrics may be selected, that may include, but are not limited to, net promoter score (NPS) (also known as “likely to recommend”), average handle time (AHT), and retention rate. Certain target metrics, such as AHT, may seek optimization through minimization of the target metric, depending on the desired outcome of the target metric.

The columns of FIG. 4 depict a listing of the available agents that are included in the test dataset. A first agent from the test dataset is represented as agent_1, a second agent represented as agent_2, and so on to a tenth agent represented as agent_10. While only ten are shown, it is within the scope of the embodiments described herein to include any number of agents. The rows of FIG. 4 depict a listing of historic interactions that are included in the test dataset. A first historic interaction from the test dataset is represented as intent_1, a second interaction represented as intent_2, and so on to a tenth interaction represented as intent_10. While only ten are shown, it is within the scope of the embodiments described herein to include any number of interactions. FIG. 4 should not be construed as limiting the number of agents or interactions as part of the generation of the agent performance scoring, and can include columns up to agent_n, representing an nth agent, and rows up to intent_m, representing an mth interaction. Contexts of interactions, representing differences in customer intent for contacting the contact center may be populated in the rows as shown in FIG. 4.

As shown in FIG. 4, the agent that would generate the best outcome for the target metric according to the generated model can be determined by finding the highest score in each row. For instance, agent_1 achieves an FCR of 1 (or 100%) while handling interactions of intent _1 but only 0.05 with intent_5. While agent_5 is not optimal at handling intent_1 interactions with a score of 0.1, agent_5 is the best with intent_5 with a score of 0.8.

A very large number of samples can be used to generate the data as shown in FIG. 4. For example, 100,000 samples may be used to generate FIG. 4 according to the distribution to ensure that lack of samples is not an issue for reliable estimation. When applied to a given contact center, the underlying distributions may reflect typical real scenarios wherein different agents are skilled at handling different types of interactions (interactions types differ in the customer intent), overall performance varies across agents, and the same agent handles different types of interactions with varying degrees of success.

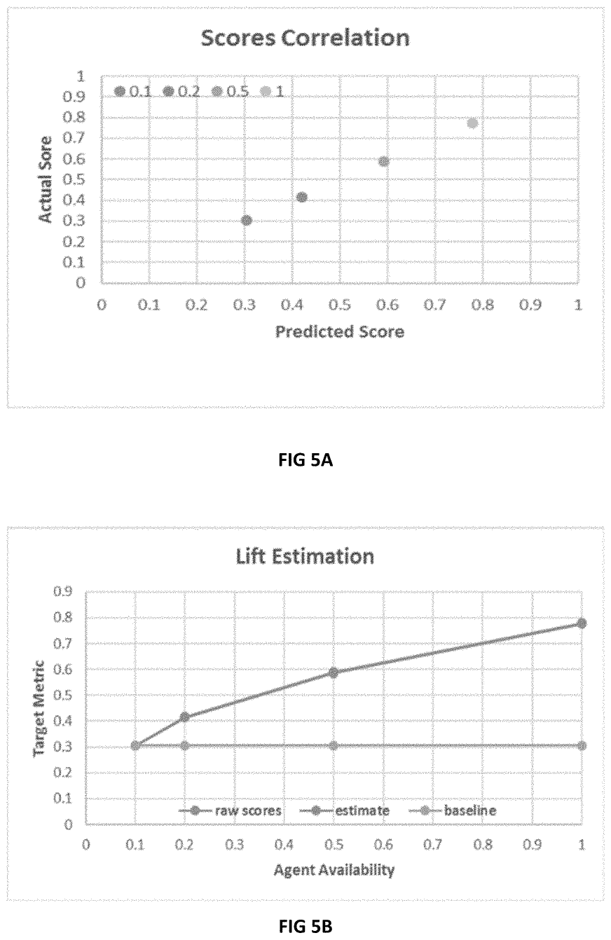

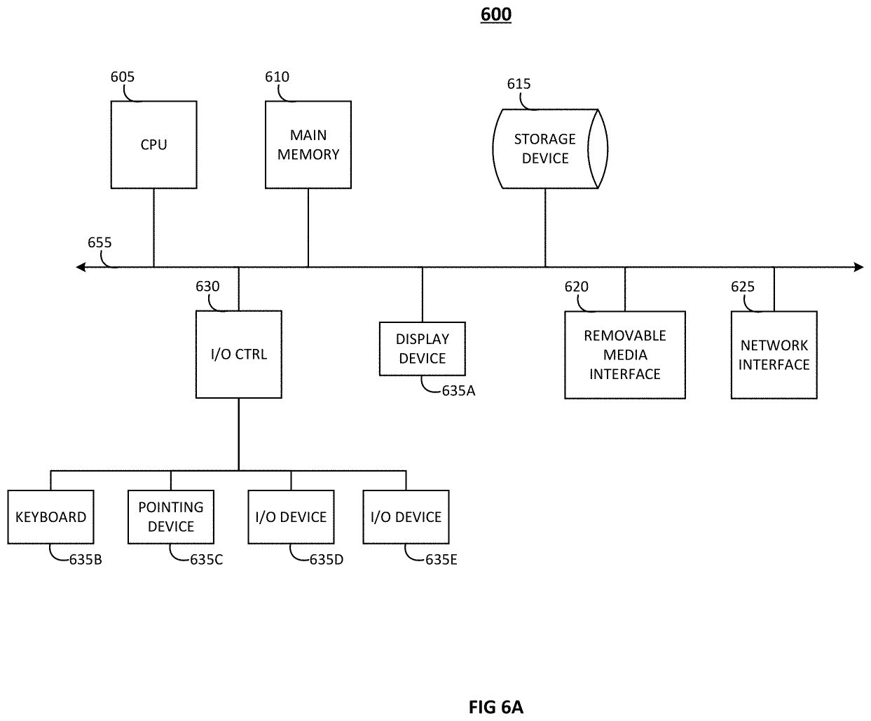

FIG. 5A is a diagram illustrating an embodiment of outcome correlation. In an embodiment, FIG. 5A depicts an exemplary scatter plot showing the correlation between a predicted outcome and a true outcome of an outcome score for a target metric for an interaction when the selected agent in the simulation matches the agent that handled the interaction. Generation of a scatter plot as shown in FIG. 5A may be used to evaluate the accuracy of the predictive model generated at operation 312 of method 300. As discussed above, for a given interaction in the test dataset, the actual score of the target metric should be closely aligned with the predicted score of the target metric when scored with the predictive model. Close correlation of the actual score and the predicted score would support validity of the generated predictive model.

The predicted score of a target metric from the generated predictive model created as a result of operation 312 (FIG. 3) is illustrated along the x-axis. In an example, the predicted score is the FCR is expressed as a decimal from 0 (0%) to 1 (100%). The actual score of a target metric from the test dataset created at operation 310 (FIG. 3) is illustrated along the y-axis. In an example, the actual score is the FCR is expressed as a decimal from 0 (0%) to 1 (100%). The results of predictive model and different set levels of agent availability are illustrated in the plot (FIG. 5A). For example, the plotted target metric of outcomes of agent-customer interactions are shown for agent availabilities of 0.1 (10%), 0.2 (20%), 0.5 (50%), and 1 (100%). FIG. 5A provides verification of the generated predicted model as the predicted score and the actual score of the target metric are closely correlated for all of the plotted agent availabilities.

FIG. 5B is a diagram illustrating an embodiment of lift estimation for a target metric. In an embodiment, FIG. 5B generally illustrates the lift estimation of the target metric over agent availability. A lift estimation curve illustrated in FIG. 5B comprises at least a baseline measurement and an estimated measurement. The lift estimation may be determined using a ROC-AUC curve between the baseline measurement and the estimated measurement. Different modeling may be displayed on the lift estimation line graph plot, including, but not limited to, a context-specific and agent-specific model, a context-specific model, a random model, and an adversarial model. A context-specific and agent-specific model includes where the output score is the mean of the target metric determined from the training data for each combination of context and agent. A context-specific model ignores agent identity and outputs a score as the mean of the target metric calculated from the training data for each value of just context without considering the agent handling the interaction. A random model ignores both context and agent and produces a random score in the range 0 to 1 to score each agent for an interaction. An adversarial model produces scores that are negatively correlated with the true agent performance, which may be used for the purpose of comparison and as a lower bound for the estimated value.

The different set levels of agent availability applied to the predictive model created as a result of operation 312 (FIG. 3) are illustrated along the x-axis of FIG. 5B. For example, the plotted agent availabilities may be expressed as a decimal from 0 (0%) to 1 (100%) availability. The predicted score of a target metric from the generated predictive model created as a result of operation 312 (FIG. 3) may be illustrated along the y-axis. For example, the predicted score may be the FCR expressed as a decimal from 0 (0%) to 0.9 (90%). Curves are plotted showing the estimated lift from the generated predictive model at operation 314 (FIG. 3). For example, in FIG. 5B, an estimated measurement and a baseline measurement of the target metric are shown (where the estimated measurement is generated through a context-specific and agent-specific model, in an embodiment). The ROC-AUC curve value of the model as shown in FIG. 5B is 0.75.

The shape of the estimated lift curve may depend on factors such as the variance in the scores across agents for each interaction. If a lot of agents have very similar scores close to the maximum score, the increase in agent availability will not have impact on the lift and a flat line across availabilities may be seen. The shape of the lift curve may depend on the generated model's accuracy. The position of the data points on the curve relative to the base line may be determined by the reliability of the predicted scores against the true outcome.

Computer Systems

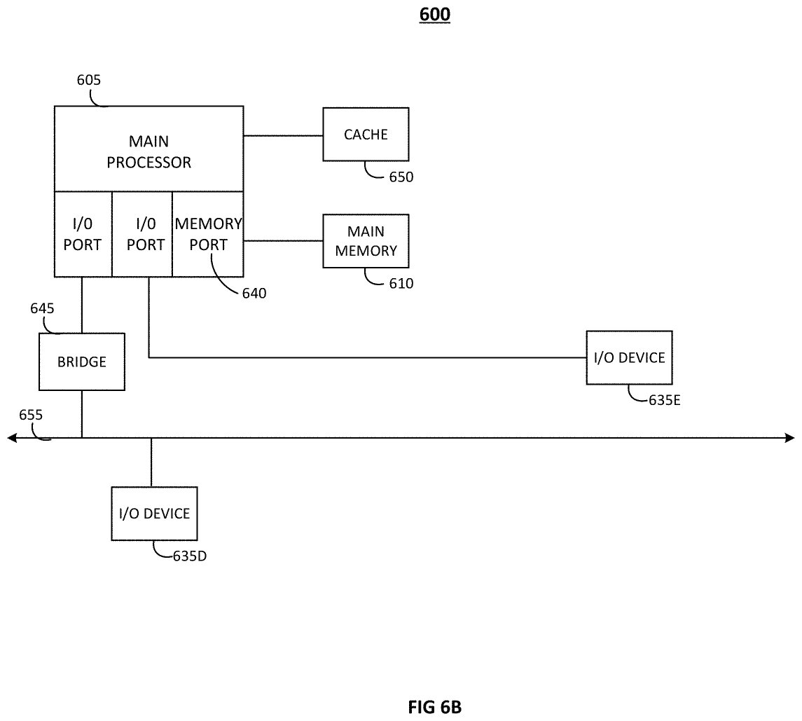

In an embodiment, each of the various servers, controls, switches, gateways, engines, and/or modules (collectively referred to as servers) in the described figures are implemented via hardware or firmware (e.g., ASIC) as will be appreciated by a person of skill in the art. Each of the various servers may be a process or thread, running on one or more processors, in one or more computing devices (e.g., FIGS. 6A, 6B), executing computer program instructions and interacting with other system components for performing the various functionalities described herein. The computer program instructions are stored in a memory which may be implemented in a computing device using a standard memory device, such as, for example, a RAM. The computer program instructions may also be stored in other non-transitory computer readable media such as, for example, a CD-ROM, a flash drive, etc. A person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JSON.

FIGS. 6A and 6B are diagrams illustrating an embodiment of a computing device as may be employed in an embodiment of the invention, indicated generally at 600. Each computing device 600 includes a CPU 605 and a main memory unit 610. As illustrated in FIG. 6A, the computing device 600 may also include a storage device 615, a removable media interface 620, a network interface 625, an input/output (I/O) controller 630, one or more display devices 635A, a keyboard 635B and a pointing device 635C (e.g., a mouse). The storage device 615 may include, without limitation, storage for an operating system and software. As shown in FIG. 6B, each computing device 600 may also include additional optional elements, such as a memory port 640, a bridge 645, one or more additional input/output devices 635D, 635E, and a cache memory 650 in communication with the CPU 605. The input/output devices 635A, 635B, 635C, 635D, and 635E may collectively be referred to herein as 635.

The CPU 605 is any logic circuitry that responds to and processes instructions fetched from the main memory unit 610. It may be implemented, for example, in an integrated circuit, in the form of a microprocessor, microcontroller, or graphics processing unit, or in a field-programmable gate array (FPGA) or application-specific integrated circuit (ASIC). The main memory unit 610 may be one or more memory chips capable of storing data and allowing any storage location to be directly accessed by the central processing unit 605. As shown in FIG. 6A, the central processing unit 605 communicates with the main memory 610 via a system bus 655. As shown in FIG. 6B, the central processing unit 605 may also communicate directly with the main memory 610 via a memory port 640.

In an embodiment, the CPU 605 may include a plurality of processors and may provide functionality for simultaneous execution of instructions or for simultaneous execution of one instruction on more than one piece of data. In an embodiment, the computing device 600 may include a parallel processor with one or more cores. In an embodiment, the computing device 600 comprises a shared memory parallel device, with multiple processors and/or multiple processor cores, accessing all available memory as a single global address space. In another embodiment, the computing device 600 is a distributed memory parallel device with multiple processors each accessing local memory only. The computing device 600 may have both some memory which is shared and some which may only be accessed by particular processors or subsets of processors. The CPU 605 may include a multicore microprocessor, which combines two or more independent processors into a single package, e.g., into a single integrated circuit (IC). For example, the computing device 600 may include at least one CPU 605 and at least one graphics processing unit.

In an embodiment, a CPU 605 provides single instruction multiple data (SIMD) functionality, e.g., execution of a single instruction simultaneously on multiple pieces of data. In another embodiment, several processors in the CPU 605 may provide functionality for execution of multiple instructions simultaneously on multiple pieces of data (MIMD). The CPU 605 may also use any combination of SIMD and MIMD cores in a single device.

FIG. 6B depicts an embodiment in which the CPU 605 communicates directly with cache memory 650 via a secondary bus, sometimes referred to as a backside bus. In other embodiments, the CPU 605 communicates with the cache memory 650 using the system bus 655. The cache memory 650 typically has a faster response time than main memory 610. As illustrated in FIG. 6A, the CPU 605 communicates with various I/O devices 635 via the local system bus 655. Various buses may be used as the local system bus 655, including, but not limited to, a Video Electronics Standards Association (VESA) Local bus (VLB), an Industry Standard Architecture (ISA) bus, an Extended Industry Standard Architecture (EISA) bus, a Micro Channel Architecture (MCA) bus, a Peripheral Component Interconnect (PCI) bus, a PCI Extended (PCI-X) bus, a PCI-Express bus, or a NuBus. For embodiments in which an I/O device is a display device 635A, the CPU 605 may communicate with the display device 635A through an Advanced Graphics Port (AGP). FIG. 6B depicts an embodiment of a computer 600 in which the CPU 605 communicates directly with I/O device 635E. FIG. 6B also depicts an embodiment in which local buses and direct communication are mixed: the CPU 605 communicates with I/O device 635D using a local system bus 655 while communicating with I/O device 635E directly.

A wide variety of I/O devices 635 may be present in the computing device 600. Input devices include one or more keyboards 635B, mice, trackpads, trackballs, microphones, and drawing tables, to name a few non-limiting examples. Output devices include video display devices 635A, speakers and printers. An I/O controller 630 as shown in FIG. 6A, may control the one or more I/O devices, such as a keyboard 635B and a pointing device 635C (e.g., a mouse or optical pen), for example.

Referring again to FIG. 6A, the computing device 600 may support one or more removable media interfaces 620, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 635 may be a bridge between the system bus 655 and a removable media interface 620.

The removable media interface 620 may, for example, be used for installing software and programs. The computing device 600 may further include a storage device 615, such as one or more hard disk drives or hard disk drive arrays, for storing an operating system and other related software, and for storing application software programs. Optionally, a removable media interface 620 may also be used as the storage device. For example, the operating system and the software may be run from a bootable medium, for example, a bootable CD.

In an embodiment, the computing device 600 may include or be connected to multiple display devices 635A, which each may be of the same or different type and/or form. As such, any of the I/O devices 635 and/or the I/O controller 630 may include any type and/or form of suitable hardware, software, or combination of hardware and software to support, enable or provide for the connection to, and use of, multiple display devices 635A by the computing device 600. For example, the computing device 600 may include any type and/or form of video adapter, video card, driver, and/or library to interface, communicate, connect or otherwise use the display devices 635A. In an embodiment, a video adapter may include multiple connectors to interface to multiple display devices 635A. In another embodiment, the computing device 600 may include multiple video adapters, with each video adapter connected to one or more of the display devices 635A. In other embodiments, one or more of the display devices 635A may be provided by one or more other computing devices, connected, for example, to the computing device 600 via a network. These embodiments may include any type of software designed and constructed to use the display device of another computing device as a second display device 635A for the computing device 600. One of ordinary skill in the art will recognize and appreciate the various ways and embodiments that a computing device 600 may be configured to have multiple display devices 635A.

An embodiment of a computing device indicated generally in FIGS. 6A and 6B may operate under the control of an operating system, which controls scheduling of tasks and access to system resources. The computing device 600 may be running any operating system, any embedded operating system, any real-time operating system, any open source operation system, any proprietary operating system, any operating systems for mobile computing devices, or any other operating system capable of running on the computing device and performing the operations described herein.

The computing device 600 may be any workstation, desktop computer, laptop or notebook computer, server machine, handled computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 600 may have different processors, operating systems, and input devices consistent with the device.

In other embodiments, the computing device 600 is a mobile device. Examples might include a Java-enabled cellular telephone or personal digital assistant (PDA), a smart phone, a digital audio player, or a portable media player. In an embodiment, the computing device 600 includes a combination of devices, such as a mobile phone combined with a digital audio player or portable media player.

A computing device 600 may be one of a plurality of machines connected by a network, or it may include a plurality of machines so connected. A network environment may include one or more local machine(s), client(s), client node(s), client machine(s), client computer(s), client device(s), endpoint(s), or endpoint node(s) in communication with one or more remote machines (which may also be generally referred to as server machines or remote machines) via one or more networks. In an embodiment, a local machine has the capacity to function as both a client node seeking access to resources provided by a server machine and as a server machine providing access to hosted resources for other clients. The network may be LAN or WAN links, broadband connections, wireless connections, or a combination of any or all of the above. Connections may be established using a variety of communication protocols. In one embodiment, the computing device 600 communicates with other computing devices 600 via any type and/or form of gateway or tunneling protocol such as Secure Socket Layer (SSL) or Transport Layer Security (TLS). The network interface may include a built-in network adapter, such as a network interface card, suitable for interfacing the computing device to any type of network capable of communication and performing the operations described herein. An I/O device may be a bridge between the system bus and an external communication bus.

In an embodiment, a network environment may be a virtual network environment where the various components of the network are virtualized. For example, the various machines may be virtual machines implemented as a software-based computer running on a physical machine. The virtual machines may share the same operating system. In other embodiments, different operating system may be run on each virtual machine instance. In an embodiment, a “hypervisor” type of virtualizing is implemented where multiple virtual machines run on the same host physical machine, each acting as if it has its own dedicated box. The virtual machines may also run on different host physical machines.

Other types of virtualization are also contemplated, such as, for example, the network (e.g., via Software Defined Networking (SDN)). Functions, such as functions of session border controller and other types of functions, may also be virtualized, such as, for example, via Network Functions Virtualization (NFV).

In an embodiment, the use of LSH to automatically discover carrier audio messages in a large set of pre-connected audio recordings may be applied in the support process of media services for a contact center environment. For example, this can assist with the call analysis process for a contact center and removes the need to have humans listen to a large set of audio recordings to discover new carrier audio messages.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method of estimating expected improvement in a target metric of a contact center, the method comprising:
extracting a first dataset over a set time interval from a database associated with the contact center, wherein the dataset comprises:
a plurality of past interaction data between customers and agents of the contact center,
associated outcomes for the interaction data, and
future availability of agents from the past interaction data;
creating a second dataset from the first dataset, wherein the second dataset comprises a training dataset and a test dataset;
building, by a predictor training server, a predictive model using the training dataset wherein the predictor training server applies a machine-learning algorithm which seeks to minimize the error in difference between true outcome for a target metric of a given interaction and a predicted outcome of the given interaction;
analyzing, by an analytics server, the test dataset using the predictive model by predicting an outcome score for the target metric for an interaction handled by an agent from a pool of the agents available in the future;
estimating the expected improvement for the target metric when each interaction is handled by an agent meeting a threshold for the outcome score; and
generating, by the analytics server, a visual representation comprising the outcome score for the target metric and the expected improvement.

2. The method of claim 1, wherein the associated outcomes for the interaction data comprise customer satisfaction survey results.

3. The method of claim 1, wherein the associated outcomes for the interaction data comprise customer satisfaction survey results.

4. The method of claim 1, wherein the test dataset comprises a most recent percentage of the first dataset as measured by time over the set time interval and the training dataset comprises a remainder of the first dataset.

5. The method of claim 4, wherein the most recent percentage is 20% and the remainder is 80%.

6. The method of claim 1, wherein the future availability of agents from the past interaction data comprises a set percentage of a number of the available agents for the contact center.

7. The method of claim 1, wherein the machine-learning algorithm comprises decision trees.

8. The method of claim 1, wherein the machine-learning algorithm comprises neural networks.

9. The method of claim 1, wherein the first dataset further comprises profile information of customers and profile information of agents and the interaction data further comprises a context associated with each interaction.

10. The method of claim 9, wherein the analyzing is performed for each of the contexts.

11. A system of estimating expected improvement in a target metric of a contact center, the system comprising:
a processor; and
a memory coupled to the processor, wherein the memory stores instructions that, when executed by the processor, cause the processor to:
extract a first dataset over a set time interval from a database associated with the contact center, wherein the dataset comprises:
a plurality of past interaction data between customers and agents of the contact center,
associated outcomes for the interaction data, and
future availability of agents from the past interaction data;
create a second dataset from the first dataset, wherein the second dataset comprises a training dataset and a test dataset;
build, by a predictor training server, a predictive model using the training dataset wherein the predictor training server applies a machine-learning algorithm which seeks to minimize the error in difference between true outcome for a target metric of a given interaction and a predicted outcome of the given interaction;
analyze, by an analytics server, the test dataset using the predictive model by predicting an outcome score for the target metric for an interaction handled by an agent from a pool of the agents available in the future;
estimate the expected improvement for the target metric when each interaction is handled by an agent meeting a threshold for the outcome score; and
generate, by the analytics server, a visual representation comprising the outcome score for the target metric and the expected improvement.

12. The system of claim 11, wherein the associated outcomes for the interaction data comprise customer satisfaction survey results.

13. The system of claim 11, wherein the associated outcomes for the interaction data comprise customer satisfaction survey results.

14. The system of claim 11, wherein the test dataset comprises a most recent percentage of the first dataset as measured by time over the set time interval and the training dataset comprises a remainder of the first dataset.

15. The system of claim 14, wherein the most recent percentage is 20% and the remainder is 80%.

16. The system of claim 11, wherein the future availability of agents from the past interaction data comprises a set percentage of a number of the available agents for the contact center.

17. The system of claim 11, wherein the machine-learning algorithm comprises decision trees.

18. The system of claim 11, wherein the machine-learning algorithm comprises neural networks.

19. The system of claim 11, wherein the first dataset further comprises profile information of customers and profile information of agents and the interaction data further comprises a context associated with each interaction.

20. The system of claim 19, wherein the analyzing is performed for each of the contexts.
